(19) United States
(12) Patent Application Publication
(10) Pub. No.: US 2010/0108645 A1
(43) Pub. Date: May 6, 2010

(54) DEVICE AND METHOD FOR AUTOMATIC UNDERWATER WELDING FOR MAKING A WELDING JOINT ON A SURFACE

(75) Inventors: Emmanuel Viard, Villeurbanne (FR); Andre Thomas, Paris (FR); Jean Mouget, Guyancourt (FR); Gabriel Merle, Chalon-sur-Saone (FR)

Correspondence Address: CONNOLLY BOVE LODGE & HUTZ LLP, 1875 EYE STREET, N.W., SUITE 1100, WASHINGTON, DC, 20006, US

(73) Assignee: AREVA NP, Courbevoie (FR)

(21) Appl. No.: 12/513,779

(22) PCT Filed: Oct. 26, 2007
(86) PCT No.: PCT/FR2007/001778

§ 371 Date: Jan. 5, 2010

(30) Foreign Application Priority Data
Nov. 7, 2006 (FR) 0609726

(51) Int. Cl. B23K 9/16

(52) U.S. Cl. 219/74

(57) ABSTRACT

The invention relates to a device for automatic under-water welding for making a welding joint (3) on a surface (2), of the type comprising a welding torch (20) including an electrode (21) surrounded by a protection envelope (23) that defines together with said electrode (21) an annular channel (24) connected to means for supplying a protection gas. The welding torch (20) is provided axially at the centre of a set (30) of two concentric envelopes (31, 32), one of which at least is capable of axial displacement and can be adjusted relative to said surface (2), said envelopes defining between them an annular gap (34) for injecting a flow for drying the welding area and keeping it away from the water.

The present invention relates to a device and a method for automatic underwater welding for the production of a joint to be welded on a surface.

Automatic underwater welding is commonly used to carry out maintenance operations or welding work, for example, in nuclear installations or in offshore installations for the extraction of oil or gas.

In the case of a nuclear installation, underwater confinement makes it possible to work and carry out operations on elements in the vicinity of radioactive or contaminated components without special precautions with respect to the cooling liquid in the vicinity of those components.

In order to effect welding operations in air with a high welding quality, it is well known to use automatic welding methods of the arc type with a consumable or non-consumable electrode, such as, respectively, welding referred to as MIG (Metal Inert Gas) or GMAW (Gas Metal Arc Welding) or TIG (Tungsten Inert Gas) or GTAW (Gas Tungsten Automatic Welding).

In the method referred to as TIG, an electric arc is created between an electrode of refractory material, such as tungsten, and the part to be welded in order to cause this part to melt. Generally, a filler metal in the form of a rod supplies the molten metal in order to fill the joint to be welded. In addition, an inert gas is directed around the electric arc on the melting bath in order to avoid oxidation under the effect of the ambient medium during welding. Generally, the gas is argon, helium or a mixture of rare gases.

In the MIG method, an electric arc is created between a consumable electrode constituting the filler material and the part to be welded in order to cause this part to melt. An inert gas is also directed around the electric arc on the melting bath in order to avoid oxidation under the effect of the ambient medium during welding.

The use of such underwater methods poses problems.

For, in order to obtain a good welding quality and to avoid excessively rapid cooling of the melting bath, it is necessary, before igniting the electric arc, to remove the water located in the welding area, then to separate the surrounding liquid medium from the electric arc before protecting the arc and keeping the welding area, that is to say, the melting bath, isolated. In addition, the ignition of the arc is effected by means of the gas circulating in the annular channel, also referred to as a nozzle, which surrounds a large portion of the electrode, and the surface of the part to be welded has to be extremely clean and dry.

Underwater welding torches which comprise around the welding electrode a first annular channel ensuring the supply of the protective gas and a second annular channel ensuring the supply of a gas for removing the surrounding liquid medium and keeping it away from the welding area are known, in particular, from the documents U.S. Pat. No. 5,981,896 and FR-A-2 837 117.

However, the devices used hitherto do not enable the welding area to be dried sufficiently and correctly before the ignition of the electric arc, so that the ignition of the electric arc is effected under poor conditions owing to the presence of moisture in the welding area.

Welding specialists know that the slightest presence of moisture impairs the quality of the weld, which is particularly serious in the nuclear field where the qualitative aspect is very important.

Furthermore, on nuclear equipment, a deposit of boron, which is contained in the water of the primary circuit, may possibly be present in the welding area, which may also impair the quality of the joint to be welded by creating incipient microcracks in the weld. The boron must therefore be removed.

The object of the invention is to provide a device and a method for underwater welding which enable these disadvantages to be eliminated, while at the same time being reliable and simple to use, and which enable welds of good quality to be obtained automatically and without human intervention underwater.

The invention therefore relates to a device for automatic underwater welding for the production of a joint to be welded on a surface, of the type comprising a welding torch having an electrode surrounded by a protective casing defining together with the electrode an annular channel connected to means for the supply of protective gas, characterized in that the welding torch is located axially in the centre of a set of two concentric casings, at least one of which is movable axially and adjustable relative to the said surface and which define between them an annular gap for the injection of a flow for drying the welding area and for keeping the welding area away from the water and in that it comprises means of displacement along the joint to be welded.

According to other features of the invention:
the welding torch comprises a means for the supply of filler metal,
the set of two casings comprises an inner casing arranged against the protective casing of the welding torch, and an outer casing,
the adjustable and axially displaceable casing is the inner casing,
the two casings of the set of two casings are displaceable axially and adjustable simultaneously or in succession,
the axial displacement of the outer casing and/or of the inner casing is from 0 to 30 mm, preferably from 2 to 20 mm, and
the flow injected into the annular gap is formed by hot or cold air or by a plasma or by a flame produced from a gaseous mixture referred to as HVOF (High Velocity Oxygen Fuel).

The invention relates also to a method for automatic underwater welding for the production of a joint to be welded on a surface, in which method a welding torch, comprising an electrode surrounded by a protective casing defining together with the electrode an annular channel for the supply of protective gas, is placed in the vicinity of the surface on a welding area of the joint to be welded, characterized in that:
a set of two concentric casings, at least one of which is displaceable axially and adjustable relative to the said surface and which define between them an annular gap, is placed around the protective casing of the welding torch, the at least one casing being displaceable between an extended position projecting relative to the end of the protective casing and a retracted position set back relative to the said end,
a flow for drying the welding area and for keeping the said area away from the water is injected into the annular gap, and a flow of protective gas is injected into the annular channel, the outer casing being in the extended position,
the welding torch and the set of two concentric casings are submerged beneath the water until the outer casing almost comes into contact with the surface,
when the welding area has been dried, the inner casing of the set of two casings is displaced into the extended position in order, by the flow of protective gas, to keep the welding area away from disturbance,
the welding torch is brought into operation,
the welding torch and the set of two cylindrical casings are displaced along the joint to be welded while keeping the welding area away from the water and away from disturbance by the injection of the flow.

According to another feature of the invention, after bringing the welding torch into operation, the outer casing of the set of two casings is lifted back into the retracted position in order to direct the flow to the outside of the welding area and to keep this area away from the water.

Other features and advantages of the invention will emerge in the course of the following description which is given with reference to the appended drawings in which:

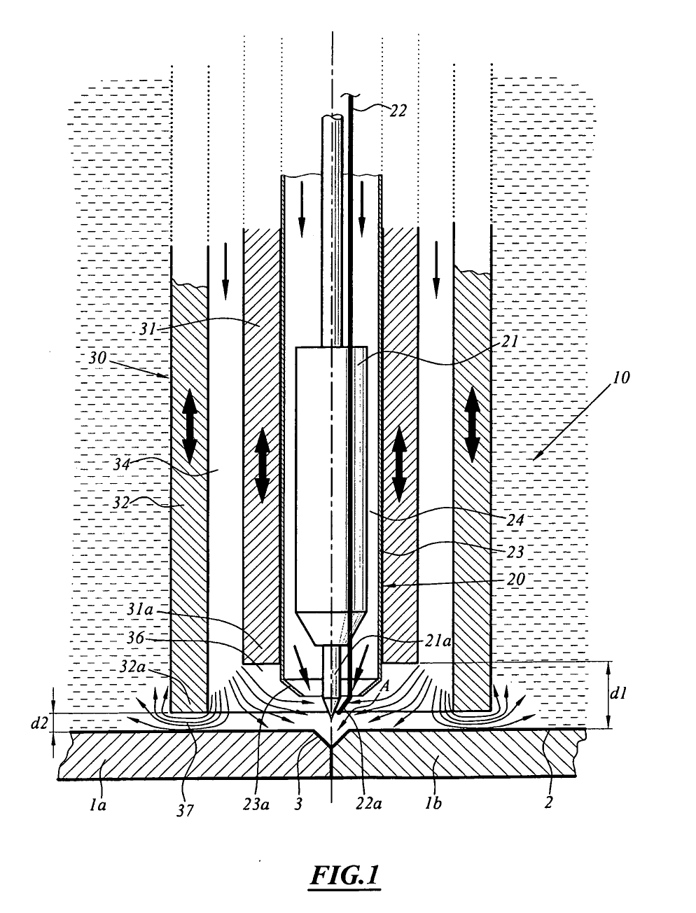

FIG. 1 is a diagrammatic view in axial section of a welding device according to the invention in the position for drying a horizontal welding area, and

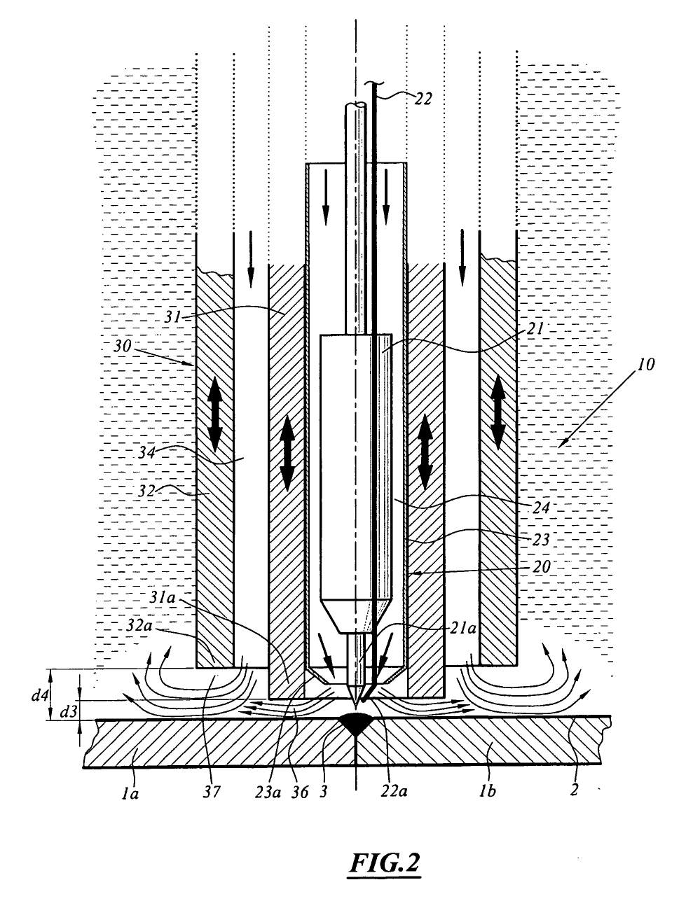

FIG. 2 is a diagrammatic view in axial section of the welding device according to the invention in the position for welding a horizontal wall.

The Figures show diagrammatically two parts 1a and 1b which define a surface 2 on which a joint 3 to be welded is to be produced by means of an automatic welding device which is indicated by the general reference 10 and which is arranged perpendicularly to the surface 2 and above the welding area A defined by the joint 3 to be welded.

The welding device 10 comprises a welding torch 20 having an electrode 21 of refractory material, generally tungsten, which is connected to means for the supply of electric power (not shown), and the free end 21a of which is located above the joint 3 to be welded.

In the embodiment shown in the Figures, the welding torch 20 is of the TIG type.

The welding torch 20 also comprises means for the supply of filler metal which are constituted by a wire 22, the free end 22a of which is located in the vicinity of the end 21a of the electrode 21, as shown in the Figures.

In the case of a welding torch of the MIG type, in a conventional manner, the means for the supply of filler metal are constituted by the electrode itself.

Finally, the welding torch 20 comprises a protective casing 23 which is arranged concentrically with respect to the electrode 21 and which defines together with that electrode 21 an annular channel 24 connected to means for the supply of protective gas. The free end 23a of the protective casing 23 converges towards the end 21a of the electrode 21 in such a manner as to channel the protective gas towards the welding area A.

The welding device 10 comprises a set 30 of two concentric casings, an inner casing 31 and an outer casing 32, respectively. The welding torch 20 is arranged axially in the centre of the set 30 and the inner casing 31 is preferably placed against the protective casing 23.

The two casings 31 and 32 of the set 30 define between them an annular gap 34 for the injection of a flow for drying the welding area A and for keeping this welding area A away from the water.

For that purpose, the annular gap 34 is connected to means (not shown) for supplying the flow and the lower ends 31a and 32a of the inner casing 31 and the outer casing 32, respectively, are located in the vicinity of the surface 2, forming with the latter a space 36 and 37, respectively.

The flow injected into the annular gap 34 is formed by hot or cold air or by a plasma or by a flame referred to as HVOF (High Velocity Oxygen Fuel).

The casings 31 and 32 of the set 30 are preferably cylindrical and at least one of these casings is movable axially and adjustable in such a manner as to modify the height of at least one space 36 and/or 37 in order to direct a larger amount of flow towards the welding area A or towards the outside of the outer casing 32, as will be seen hereinafter.

In general, the at least one casing 31 and/or 32 is displaceable axially between an extended position projecting relative to the end of the protective casing 23 and a retracted position set back relative to the said end.

According to a first embodiment, only the inner casing 31 is movable longitudinally and adjustable in order to modify the height of the space 36.

According to a second embodiment, the two casings 31 and 32 are displaceable axially and adjustable simultaneously or in succession in order to modify separately or at the same time the height of the spaces 36 and 37.

The axial displacement of the inner casing 31 and/or of the outer casing 32 of the set 30 is from 0 mm to 30 mm, preferably from 2 mm to 20 mm, relative to the surface 2 of the parts 1a and 1b.

This axial displacement and the height adjustment of one or both spaces 36 and 37 of the casings 31 and 32, respectively, are effected by suitable means of known type, such as, for example, mechanisms having a rack and pinion, a screw and nut system, a pneumatic or hydraulic jack, an electrical motor or an electromagnetic system or by any other mechanism.

The joint 3 to be welded of the underwater parts 1a and 1b is produced in the following manner.

First of all, the working end 21a of the electrode 21, the end 22a of the filler wire 22 and the end of the protective casing 23, these various elements forming the welding torch 20, are prepared, in the air, above the surface of the water and in a manner substantially perpendicular to the surface 2, and the set 30 comprising the inner casing 31 and the outer casing 32 is placed around the protective casing 23 of the welding torch 20.

In a first step, a flow for drying the welding area A and keeping it away from the water is injected into the annular gap 34 defined by the two annular concentric casings 31 and 32, and a flow of gas for protecting the welding area A is injected into the annular channel 24 surrounding the electrode 21, the outer casing 32 being in the extended position.

The welding device 10 constituted by the welding torch 20, and the set 30 of two casings 31 and 32 are then submerged beneath the water until the outer casing 32 almost comes into contact with the surface 2 and, as shown in FIG. 1, at least one casing 31 or 32 of the set 30 of two casings is displaced axially along the welding torch 20 in order to adjust the height of the spaces 36 and 37 formed between the ends 31a and 32a, respectively, of those casings, and the surface 2 of the parts 1a and 1b. In the course of this first step, the aim is to dry the welding area A in order to eliminate any trace of water and also any trace of moisture from this welding area A before the welding torch 20 is ignited.

For that purpose, the inner casing 31 is kept in the retracted position, away from the surface 2, and the outer casing 32 is kept in the extended position, close to the surface 2, so that the height d1 of the space 36 is greater than the height d2 of the space 37. In this position, the larger amount of flow injected into the annular gap 34 is directed towards the welding area A, which enables this welding area A to be dried rapidly and any trace of moisture to be removed. Some of the flow injected into the annular gap 34 passes via the space 37 and enables the welding area A to be kept away from the water.

In the course of a second step, the casings 31 and 32 of the set 30 are displaced axially along the welding torch 20 in order to modify the distribution of the flow introduced into the annular gap 34.

As shown in FIG. 2, the inner casing 31 is displaced into the extended position, close to the surface 2, and the outer casing 32 is in the retracted position, away from the surface 2, so that the height d3 of the space 36 is smaller than the height d4 of the space 37 in order to direct the larger amount of flow injected into the annular gap 34 towards the outside of the outer casing 32 and to create a quiet welding area sheltered from disturbances caused by the drying flows.

Therefore, the flow injected into the annular gap 34 added to the flow of protective gas injected into the annular channel 24 enables the welding area A to be kept dry and also away from the water.

The welding torch 20 is then brought into operation and it, as well as the set 30 of two casings, is displaced by suitable means of known type along the joint 3 to be welded in order to produce the entire weld, while at the same time keeping the welding area away from the water and away from disturbance.

The modification of the distribution of the flow injected via the annular gap 34 by adjusting the height of the spaces 36 and 37 by the axial displacement of the casings 31 and 32 makes it possible, in the course of a first step, to dry the welding area A efficiently and rapidly and, in the course of a second step, to ignite the welding torch under good conditions, and then to keep this welding area A dry and away from the water and above all away from disturbance so that the weld is produced under ideal conditions.

Depending on the conditions of use, the adjustment of the position of the inner casing 31 or of the two casings 31 and 32 can be regulated in the course of the displacement of the welding torch 20 along the joint to be welded.

In addition, any boron present in the welding area is removed from this welding area by the flow injected into the annular channel 34, which contributes to the quality of the joint to be welded by removing the risk of the formation of microcracks in this welded joint owing to the presence of the boron.

Of the various flows which can be injected into the annular channel 34, plasma and the HVOF flame are preferably used owing to their very high temperature, which may be greater than 1000° C. in the case of plasma, while hot air is at a maximum temperature of 150° C. This high temperature of the plasma flow enables, in addition to the physical thrust of the flow, the surrounding water to be evaporated, which hot air cannot do.

It should be noted that the high temperature of the plasma flow nevertheless enables the physico-chemical integrity of the material to be welded to be maintained.

Furthermore, the axial displacement of the inner casing 25, 31 and/or of the outer casing 32 relative to the surface 2 ranges from 0 mm to 30 mm, depending on whether the step prior to igniting the welding torch 20 or the production of the welded joint itself is involved.

During the production of the welded joint, the injection of flow into the annular channel 34 and around the welding area A enables this welding area A to be kept under excess pressure relative to the pressure of the surrounding water.

By means which are reliable and easy to use, the welding device according to the invention enables welds of good quality to be obtained automatically and without human intervention underwater.

A miniature camera may be placed in the vicinity of the welding area, in particular in the annular channel 24, in order to participate in the correct performance of the welding operation by giving visual indications to the operator located at a distance.

A pressure sensor may be placed in at least one annular channel for the supply of the drying flow or the supply of the gas for protecting the welding bath in order to participate in a remote adjustment of the flow rates and pressures of those flows or gases.

The welds can be produced by the welding device according to the invention in any position on flat or optionally curved surfaces.

1. Device for automatic underwater welding for the production of a welded joint on a surface, of the type comprising a welding torch having an electrode surrounded by a protective casing defining together with the electrode an annular channel-PO connected to means for the supply of protective gas,
wherein the welding torch is located axially in the centre of a set of two concentric casings, at least one of which is movable axially and adjustable relative to the said surface and which define between them an annular gap for the injection of a flow for drying the welding area and for keeping the welding area away from the water and in that it comprises means of displacement along the joint to be welded.

2. Device according to claim 1, wherein the welding torch comprises a means for the supply of filler metal.

3. Device according to claim 1, wherein the set of two casings comprises an inner casing arranged against the protective casing of the welding torch, and an outer casing.

4. Device according to claim 1, wherein the adjustable and axially displaceable casing is the inner casing.

5. Device according to claim 1, wherein the two casings of the set of two casings are displaceable axially and adjustable simultaneously or in succession.

6. Device according to claim 1, wherein the axial displacement of the inner casing and/or of the outer casing is from 0 to 30 mm, preferably from 2 to 20 mm.

7. Device according to claim 1, wherein the flow injected into the annular gap is formed by hot or cold air or by a plasma or by a flame produced from a gaseous mixture referred to as HVOF (High Velocity Oxygen Fuel).

8. Method for automatic underwater welding for the production of a joint to be welded on a surface, in which method a welding torch, comprising an electrode surrounded by a protective casing defining together with the electrode an annular channel for the supply of protective gas, is placed in the vicinity of the surface on a welding area of the joint to be welded, wherein:
a set of two concentric casings, at least one of which is displaceable axially and adjustable relative to the said surface and which define between them an annular gap, is placed around the protective casing of the welding torch, the at least one casing being displaceable between an extended position projecting relative to the end of the protective casing and a retracted position set back relative to the said end,
a flow for drying the welding area and for keeping the said area away from the water is injected into the annular gap, and a flow of protective gas is injected into the annular channel, the outer casing being in the extended position,
the welding torch and the set of two concentric casings are submerged beneath the water until the outer casing almost comes into contact with the surface,
when the welding area has been dried, the inner casing of the set of two casings is displaced into the extended position in order, by the flow of protective gas, to keep the welding area away from disturbance,
the welding torch is brought into operation,
the welding torch and the set of two cylindrical casings are displaced along the joint to be welded while keeping the welding area away from the water and away from disturbance by the injection of the flow.

9. Method according to claim 8, wherein, after bringing the welding torch into operation, the outer casing of the set of two casings is lifted back in order to direct the flow to the outside of the welding area and to keep this area away from the water.
